(19) United States
(12) Patent Application Publication
(10) Pub. No.: US 2003/0120836 A1
(43) Pub. Date: Jun. 26, 2003

(54) Memory system

(76) Inventor: David Stuart Gordon, Farnborough (GB)

Correspondence Address: B. Noel Kivlin, Meyertons, Hood, Kivlin, Kowert & Goetzel, P.C., P.O. Box 398, Austin, TX, 78767, US

(21) Appl. No.: 10/326,429

(22) Filed: Dec. 19, 2002

(30) Foreign Application Priority Data
Dec. 21, 2001 (GB) 0130711.5

(51) Int. Cl. G06F 13/28

(52) U.S. Cl. 710/22

(57) ABSTRACT

A computer system is described having a proxy DMA unit which is used as an intermediary during direct memory access operations performed by a conventional DMA controller. The proxy DMA unit is provided with check summing circuitry which calculates a check sum for the data transferred between system memory and an external peripheral device. The check sum is subsequently used by the computer system to validate the data when it is read back to the system memory via the proxy DMA unit thus generating a second check sum. If the two check sums are the same the data is uncorrupted whereas if they are different the data is corrupted and remedial procedures can be initiated.

### FIELD OF THE INVENTION

The present invention relates to a direct memory access system which incorporates hardware checksumming capabilities.

### BACKGROUND OF THE INVENTION

A large part of the work carried out by a computer device is the storage and retrieval of data to and from data storage devices. In early computer systems this work was carried out by the central processing unit (CPU), requiring the use of a substantial portion of the CPU's available computing capacity to perform the detailed steps of the storage or retrieval operation. However, in modern systems the mechanics of data transfer to and from storage devices is often carried out by a separate direct memory access (DMA) controller. The DMA controller performs the transfer without the direct intervention of the CPU and therefore leaves the CPU free to attend to other computations. In such systems, to initiate the data transfer, the CPU programs the DMA controller with details of the data to be transferred including its source location, its destination and the amount of data to be transferred and then issues a command to begin the transfer. When the transfer has been completed the DMA controller informs the CPU of the completion, whereupon the CPU may make use of the results of the transfer.

In computing systems requiring high reliability data storage and retrieval, it may be necessary or desirable to keep check information for each block of data that is stored, which check information can be used to validate that the data has not become corrupted during storage. One common form of check information is called a checksum which is the result of a mathematical calculation on the block of data that produces the same result each time it is calculated. If a checksum is calculated on a block of data that is about to be stored, when the data is retrieved the checksum can then be re-calculated on the retrieved data and compared with the stored checksum.

If the newly computed checksum differs from the stored checksum then the data is known to be corrupt and remedial measures can be initiated.

Although checksumming may be performed in software either by the device driver or the application requesting the data, such software checksumming requires a sequence of memory accesses and computational steps to be performed by the CPU, thereby adding to the CPU overhead required before the data can safely be used.

Rather than being performed in software, the checksumming may be performed by dedicated hardware. The applicant has already proposed a system (the ftSPARC system) which incorporated DMA hardware with checksumming. A limitation of the ftSPARC system is that it will not work with conventional peripheral devices which have their own built-in DMA controllers, nor will it work with standard DMA chips that are used throughout the computing industry.

### SUMMARY OF THE INVENTION

According to one aspect, the present invention provides an alternative hardware solution to providing DMA with check data.

According to one aspect, the present invention provides a computer system which uses a direct memory access controller to control accesses to system memory by an external peripheral device. The system also includes another DMA controller (hereinafter referred to as a proxy DMA unit) via which the main DMA controller writes data to and reads data from the system memory. The proxy DMA unit includes circuitry for calculating check data for use in validating the transferred data. The system is arranged to operate with conventional DMA controllers in that when the CPU instructs the main DMA controller to carry out the direct memory access operation, the CPU provides the DMA controller with an address to which the proxy DMA unit, rather than the system memory, responds. In one embodiment, the proxy DMA unit includes an address mapping table which translates an address provided by the DMA controller into an appropriate physical address of the system memory.

In one embodiment, the processing unit can configure the DMA controller either to carry out the transfer via the proxy DMA unit or directly from system memory. This allows the proxy DMA unit to operate efficiently in conjunction with devices which do not require checking of the transferred data such as printers or the like.

### BRIEF DESCRIPTION OF THE DRAWINGS

Exemplary embodiments of the present invention will now be described with reference to the accompanying drawings in which like numerals refer to like elements and in which:

FIG. 1 is a block diagram illustrating the main components of a computer system embodying the present invention;

FIG. 2 is a block diagram illustrating the main components of a proxy DMA unit forming part of the computer system shown in FIG. 1;

FIG. 3 is a schematic diagram illustrating some of the signals transferred on control and address buses forming part of the computer system shown in FIG. 1;

FIG. 4a is a flowchart illustrating part of the flow control during the transfer of data between a memory device and a hard disk using the DMA proxy unit shown in FIG. 2;

FIG. 4b is a flowchart illustrating the remaining part of the flow control during the transfer of data between a memory device and a hard disk using the DMA proxy unit shown in FIG. 2;

FIG. 5 is a block diagram illustrating the layout of another computer system embodying the present invention;

FIG. 6 is a block diagram illustrating the main components of a proxy DMA unit used in the computer system shown in FIG. 5;

FIG. 7 is a block diagram illustrating the system architecture of an alternative computer system embodying the present invention;

FIG. 8 is a block diagram illustrating the main components of a proxy DMA unit used in the computer system shown in FIG. 7;

FIG. 9a is a flow chart illustrating part of the processing operations performed during a data transfer between a hard disk and system memory of the computer system shown in FIG. 7; and

FIG. 9b is flow chart illustrating the remaining operations performed during the data transfer between the peripheral device and the system memory shown in FIG. 7.

### DETAILED DESCRIPTION OF SPECIFIC EMBODIMENTS

First Embodiment

A first embodiment of the invention will now be described in which a proxy DMA unit is provided and used as an intermediary during direct memory access operations performed by a conventional DMA controller and which proxy DMA unit provides checksumming of the data that is transferred.

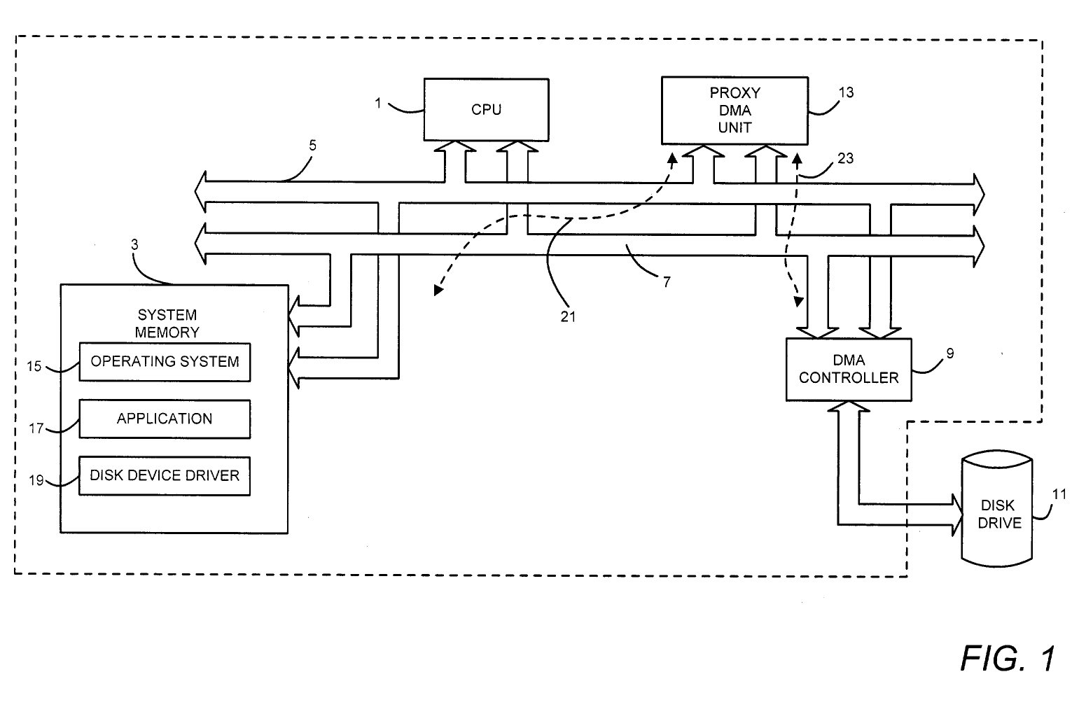

FIG. 1 is a block diagram showing the main components of a computer system having a central processing unit (CPU) 1 connected to a system memory 3 via a system address and control bus 5 and a system data bus 7. A DMA controller 9 is also provided in the form of a separate integrated circuit which is also connected to the system address and control bus 5 and the system data bus 7 and operates, in this embodiment, to control the transfer of data between the system memory 3 and a storage disk drive 11. The DMA controller 9 is a standard DMA controller such as the Symbios SCSI I/O processor (SYM53C875).

The system memory 3 is shown as a single block of memory but includes the computer's RAM and in practice may be distributed at different physical locations on the system bus 5,7. As illustrated in FIG. 1, the system memory 3 stores software for controlling the computer system and data (not shown) used by the computer system. In particular, the memory 3 stores the operating system software 15 which operates as the controlling interface between user application software (such as a word processor) and the computer hardware. The memory system 3 also stores one or more of the user applications 17 together with appropriate device drivers for controlling the transmission of data between connected devices and the computer system. As shown in FIG. 1, in this embodiment, there is a disk device driver 19 for controlling communications with the disk drive 11.

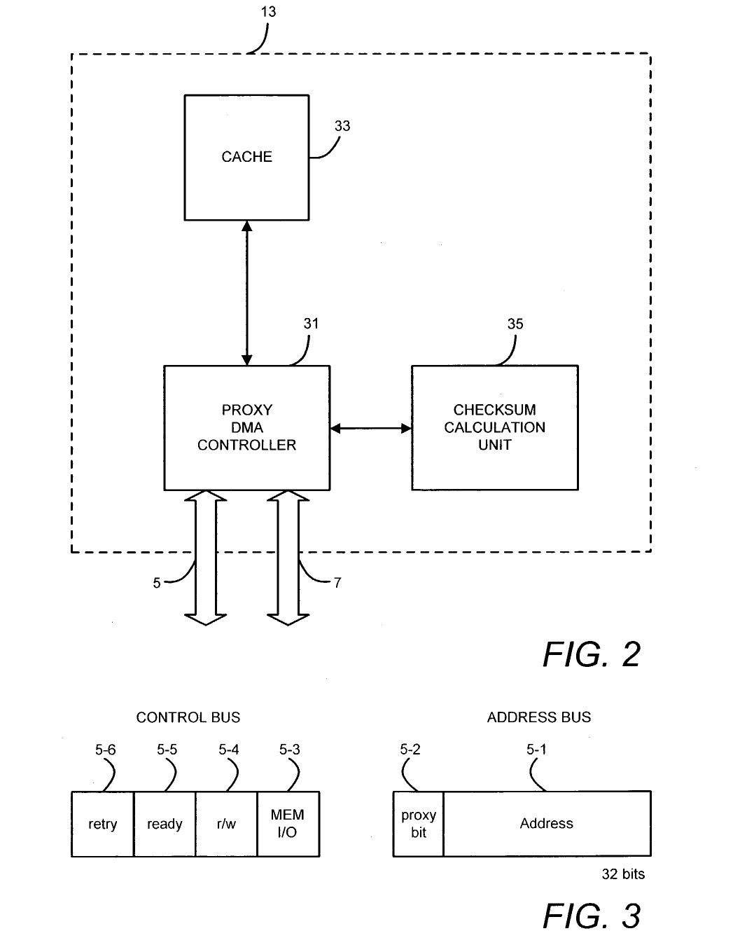

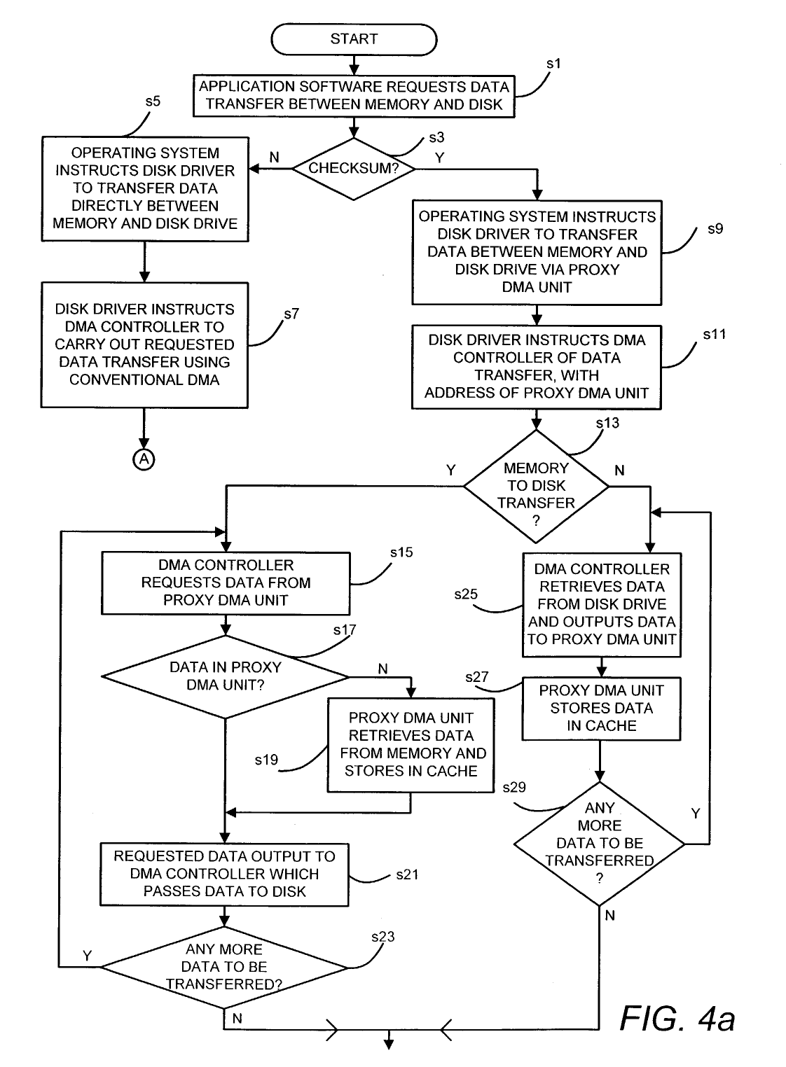

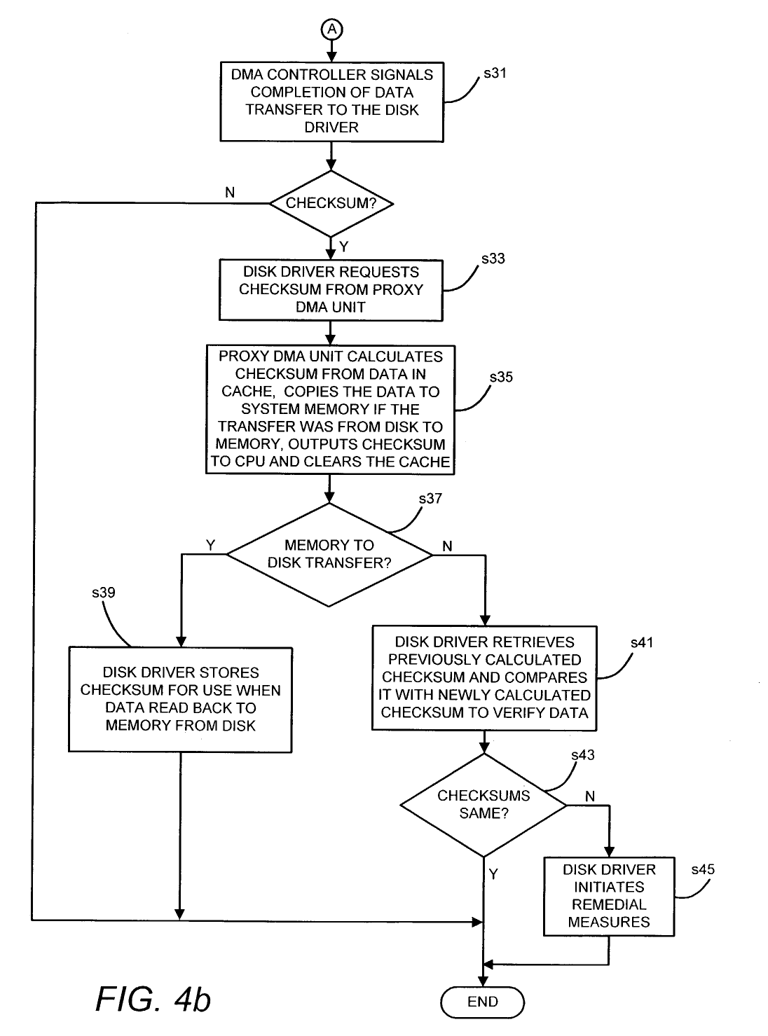

AS shown in FIG. 1, in addition to the above components the computer system also has a proxy DMA unit 13 which is also connected to the system address and control bus 5 and the system data bus 7. The main components of the proxy DMA unit 13 are shown in more detail in FIG. 2. As shown, the proxy DMA unit 13 includes a proxy DMA controller 31 for controlling the operation of the proxy DMA unit 13, a cache memory 33 for storing data to be transferred between the system memory 3 and the disk drive 11 and a checksum calculation unit 35 for performing a checksum operation on the transferred data. In this embodiment, the proxy DMA controller 31 is arranged to respond to a predetermined set of addresses applied to the address and control bus 5. In particular, in this embodiment, one of the bits of the address presented by the DMA controller 9 and appearing on the system address bus 5 is dedicated to selecting whether the system memory 3 is addressed directly or via the proxy DMA unit 13; thus, two images of memory appear in the system address map, one without and one with checksumming. FIG. 3 illustrates the bits used in the address and control bus 5. The address part of the bus includes 31 bits 5-1 for addressing 231 memory locations within the system memory 3 and a proxy DMA bit 5-2 for selecting whether the system memory 3 is addressed directly or via the proxy DMA unit 13. The control part of the address and control bus 5 includes a memory input/output bit 5-3 for addressing the DMA controller 9; a read/write bit 5-4 for specifying whether or not data is to be read from or written to the system memory 3; a ready bit 5-5 for specifying that data is ready to be read from the data bus 7; and a retry bit 5-6 which is used to indicate to the DMA controller 9 to retry at a later time.

The operation of the computer system shown in FIGS. 1 and 2 and in particular the way in which the proxy DMA unit 13 operates will now be described in more detail with reference to the flowchart shown in FIG. 3. As is well known, the CPU 1 executes instructions corresponding to the operating system software 15 and, when running, the user application software 17 and the disk device driver 19. As shown, when data is to be transferred from the system memory 3 to the disk drive 11 or vice versa in response to, for example a user input via the application software 17 (e.g. in response to a save command), the application software requests the data transfer (s1). Upon receipt of the request, the operating system 15 determines whether or not the transfer is to be checksummed (s3). If the data is not to be checksummed then the operating system instructs the disk device driver 19 to transfer the requested data directly between the memory 3 and the disk drive 11 using the DMA controller 9 without the proxy DMA unit 13 (s5). The disk driver 19 then instructs the DMA controller 9 to carry out the required data transfer in the conventional manner (s7) by not setting the proxy bit 5-2 of the address and control bus 5.

If, however, the data transfer is to take place with a checksum of the data, then the operating system 15 instructs the disk driver 19 to transfer the data between the system memory 3 and the disk drive 11 via the proxy DMA unit 13 (s9). In this embodiment, this is done by the operating system 15 providing the addresses for the locations in the system memory 3 together with the proxy bit 5-2 of the addresses set so that when the DMA controller 9 eventually outputs those addresses on the address and control bus 5, the proxy DMA unit 13 will respond to those addresses rather than the system memory 3. The disk driver 19 then instructs the DMA controller 9 of the data to be transferred together with the addresses provided by the operating system 15 (s11). In particular, the disk driver 19 informs the DMA controller 9 if data is to be read from or written to the system memory 3, the starting address (5-1) in the system memory 3 (with the proxy DMA bit (5-2) set) detailing where the beginning of the data is to be read from or written to the system memory 3, the size of the data block to be transferred and the location in the disk drive 11 to which or from which the data is to be transferred.

Upon receipt of the instruction, the DMA controller 9 determines if the data is to be transferred from system memory 3 to disk drive 11 or from disk drive 11 to system memory 3 (s13). If the transfer is from memory 3 to disk 11, then the DMA controller 9 requests the data from the proxy DMA unit 13 (s15). It does this simply by outputting the address of the data (provided to it by the disk driver 19) onto the address and control bus 5. As this address has the proxy DMA bit 5-2 set, the system memory 3 ignores it and it is read in and dealt with by the proxy DMA unit 13. In particular, the proxy DMA controller 31 checks to see whether or not the data that the DMA controller 9 wishes to retrieve from the system memory 3 is already stored in its internal cache 33 (s17). If the data is not already stored in its internal cache 33, the proxy DMA controller 31 first asserts the retry signal 5-6 to the DMA controller 9. It then retrieves the requested data from the system memory 3 (s19) by resetting the proxy DMA bit 5-2 and outputting the received address portion 5-1 back onto the system and control bus 5 (with the read/write bit 5-4 set for a read operation). The system memory 3 responds by outputting the data from that address onto the system data bus 7 and by setting the ready bit 5-5 to indicate that the data can be read from the data bus 7. When the proxy DMA controller 31 sees the setting of the ready bit 5-5, it reads the data from the data bus 7 into the cache 33.

In this embodiment, rather than retrieving data individually from the system memory 3 in response to requests from the DMA controller 9, the proxy DMA unit 13 retrieves a block of data starting at the initial address specified by the DMA controller 9. It does this, since it is likely that the next data request from the DMA controller 9 will be for data in a subsequent memory address.

When the DMA controller 9 retries the read transaction, the proxy DMA unit 13 now finds that it has the required data in its cache 33 and provides the requested data to the DMA controller 9, which in turn passes the data to the disk drive 11 in the normal way (s21).

The DMA controller 9 then checks whether or not any more data is to be transferred (s23). If there is, then the processing returns to s15 where the processing proceeds as before with the DMA controller 9 requesting the next data word.

A transfer of data from the disk drive 11 to the system memory 3 operates in a similar way. Initially, the DMA controller 9 retrieves the data from the disk drive 11 in a conventional manner and outputs the data onto the data bus 7 and the relevant address (with the proxy bit 5-2 set) on the address and control bus 5, thereby causing the data to be passed to the proxy DMA unit 13 (s25). In this case, the address portion 5-1 will specify the address in system memory 3 to which the data should be written and the read/write bit 5-4 will be set for a write operation. In this embodiment, the proxy DMA 13 unit stores the received data within its internal cache 33 (s27). The DMA controller 9 then considers whether or not any more data is to be transferred (s29). If there is, the processing returns to s25.

Once all of the data has been transferred by the DMA controller 9 the processing passes either from s23 or s29 to s31 where the DMA controller 9 signals to the disk driver 19 that it has completed the data transfer in the normal way. The disk driver 19 then determines if the data transfer was checksummed (s32) and if it was not then the processing ends. If the data transfer was checksummed then the disk driver 19 requests the checksum from the proxy DMA unit 13 (s33). In response, the proxy DMA unit 13: (i) calculates the checksum from the data that was transferred by the DMA controller 9 (a copy of which is still stored in the cache 33); (ii) copies the data to system memory 3 if the transfer was from disk drive 11 to system memory 3; (iii) outputs the checksum to the disk driver 19; and (iv) clears the cache 33 (s35).

What happens next to the checksum depends upon whether or not the data was a transfer from the system memory 3 to the disk drive 11 or from the disk drive 11 to the system memory 3 (s37). If the transfer was from system memory 3 to the disk drive 11 then the disk driver 19 stores the calculated checksum (either in the system memory 3 or in the disk drive 11) for future comparison with the checksum calculated when the same data is read back from the disk drive 11 into the system memory 3 (s39). If the data transfer is from disk drive 11 to the system memory 3, then the disk driver 19 retrieves the checksum that was calculated when the same data was transferred from the system memory 3 to the disk drive 11 and compares it with the newly calculated checksum (s41). If the checksums are the same (s43) then the data has not been corrupted and the processing ends. If however the checksums are not the same then the data has become corrupted at some point and the disk driver 19 initiates remedial procedures (s45). In this embodiment, if the checksums are different, then the disk driver 19 instructs the DMA controller 9 to read the data back again from the disk drive 11. If the checksums are still different the disk driver 19 informs the application software 17 of the corruption of the data.

As those skilled in the art will appreciate from the above description, the computer system shown in FIG. 1 can operate: (i) so that a conventional DMA operation can occur without checksumming in which case the data is transferred between the system memory 3 and the disk drive 11 without being routed through the proxy DMA unit 13; or (ii) so that a DMA operation can be performed with checksumming in which case the data is transferred between the system memory 3 and the disk drive 11 via the proxy DMA unit 13 (as indicated by the dashed arrows 21 and 23 shown in FIG. 1). As those skilled in the art will appreciate, since the DMA controller 9 does not know that it is not accessing the system memory 3 directly (when checksumming is being performed), conventional “off the shelf” DMA chips can be used.

One of the advantages of the proxy DMA architecture is that it can cope with the irregular data transfers often performed by conventional DMA controllers 9. In particular, conventional DMA controllers often request, during one DMA transfer, the same data more than once. They also often request the data to be transferred out of order with respect to the order in which it is stored. Since the proxy DMA unit 13 participates in the data transfer rather than merely observing the data transfer, the proxy DMA unit 13 is able to calculate correctly the checksums for the actual block of data that is transferred to or from system memory rather than merely the data as it appears on the data bus 7 (which might include duplicated or out of sequence elements).

Second Embodiment

A second embodiment of the invention will now be described. In the first embodiment the selection of whether or not to perform the DMA transfer with checksumming was effectively controlled through the setting of the proxy DMA bit 5-2 which forms part of the address and control bus 5. Further, in the first embodiment the DMA controller 9 was connected directly to the system address and control bus 5 and data bus 7.

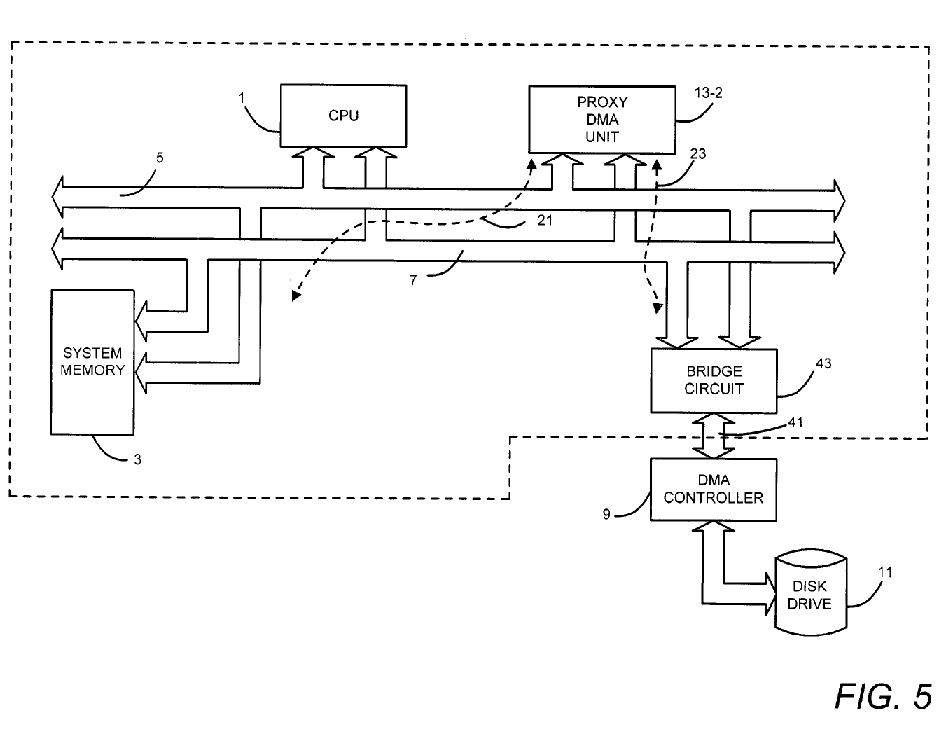

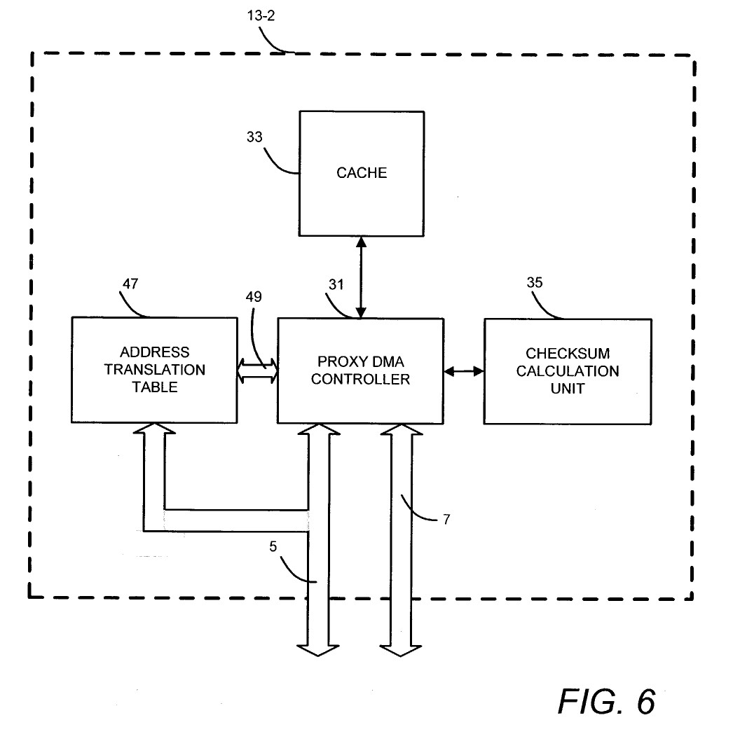

In the second embodiment as shown in FIG. 5, the DMA controller 9 is located on an input/output (I/O) bus 41 which is connected to the system address and control bus 5 and data bus 7 via a bridge circuit 43. The components in the second embodiment which are the same as those of the first embodiment are labelled with the same reference number and will not be described again. In this embodiment, the bridge circuit 43 is a conventional bridge circuit which translates the signals on the I/O bus 41 into appropriate signals for the system address and control bus 5 and the system data bus 7 and vice versa. The operation of this embodiment is similar to the operation of the first embodiment described above except that, as shown in FIG. 6, the proxy DMA unit 13-2 is provided with an address translation table 47. In this embodiment, the address translation table 47 is a look-up table which translates the virtual address applied to the system address and control bus 5 by the DMA controller 9 into an appropriate physical address in the system memory 3, which it passes to the proxy DMA controller 31 on the internal bus 49. In this embodiment, at the end of the DMA transfer operation, the CPU 1 polls the proxy DMA unit 13-2 for the checksum by outputting a predetermined address on the address and control bus 5 which gets translated into the request for the checksum by the proxy DMA controller 31. Further, the contents of the address translation table 47 may be changed by the CPU 1 thereby allowing different devices to use the same virtual addresses which are translated into different physical addresses. In this way, the proxy DMA unit 13-2 can operate with more than one external device which operates with a DMA controller. In such an embodiment, the CPU 1 would reconfigure the address translation table 47 stored in the proxy DMA unit 13-2 depending on which external device is seeking to transfer data with the system memory 3.

Third Embodiment

A third embodiment of the invention will now be described. In the first and second embodiments described above the proxy DMA unit 13 was designed to sit “to the side of” (in parallel to) the main system buses 5 and 7. Such a parallel architecture provides flexibility in that the DMA controller 9 can be instructed to address the system memory 3 directly for transfers where checksumming is not required or via the proxy DMA unit 13 when checksumming is required. In the third embodiment the proxy DMA unit 13-3 is connected in series between the DMA controller 9 and the system buses 5 and 7. In this case, the proxy DMA unit 13-3 also performs the role of the bridge circuit 43 used in the second embodiment described above.

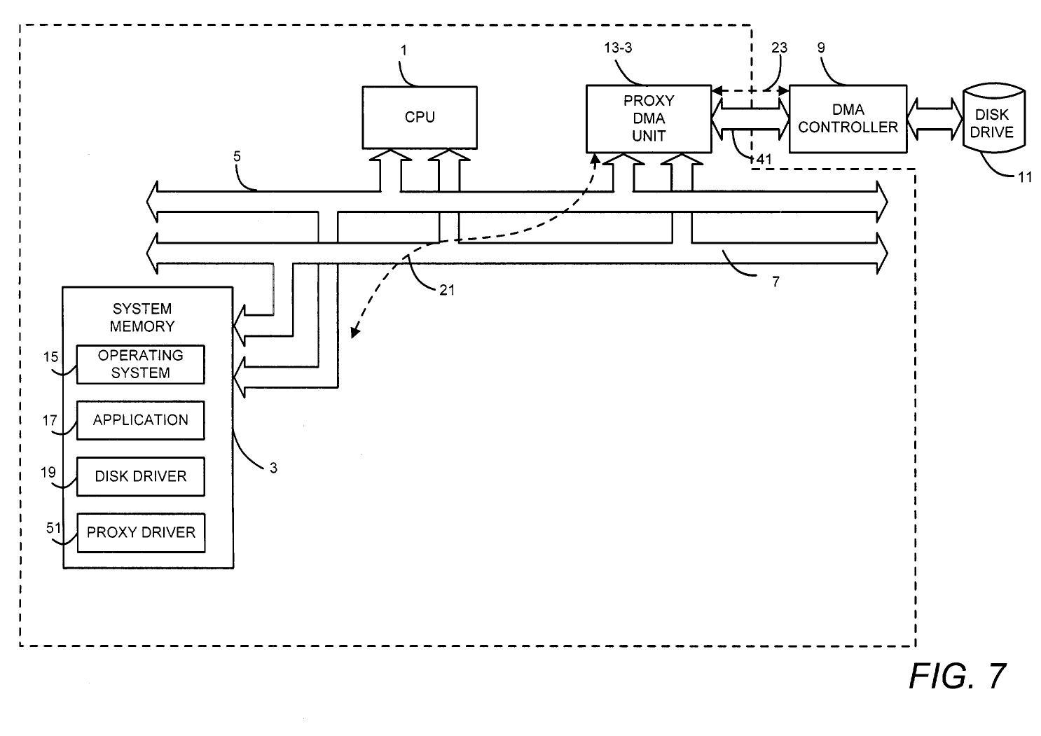

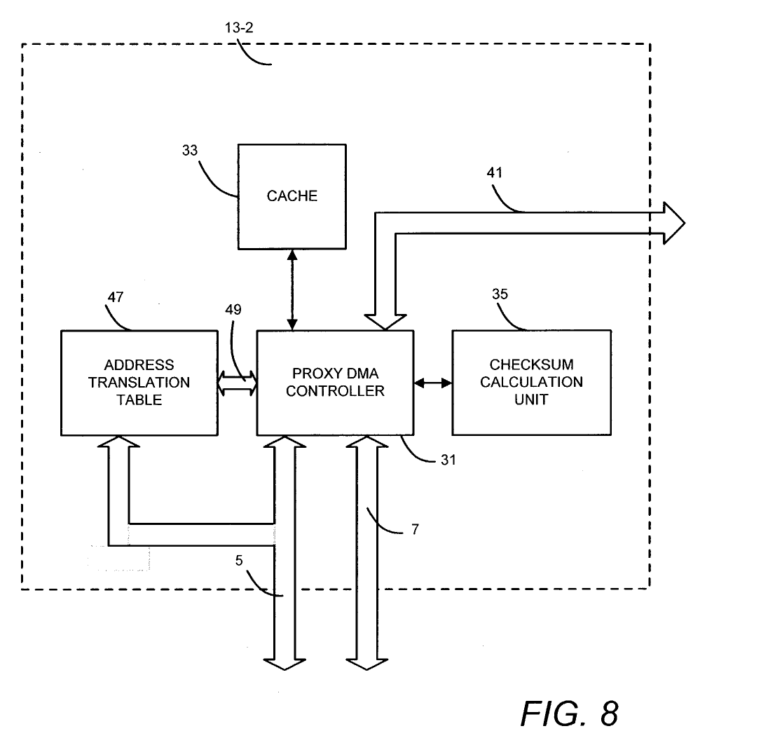

FIG. 7 is a schematic block diagram illustrating the architecture of the computer system according to the third embodiment. The components in the third embodiment which are identical to those of the first and second embodiments are labelled with the same reference number and will not be described again. As shown in FIG. 7, the DMA controller 9 and the disk drive 11 interface with the system address and control bus 5, the system data bus 7 and the system memory 3 via the proxy DMA unit 13-3.

FIG. 8 shows in more detail the components of the proxy DMA unit 13-3 used in this third embodiment. As shown, the main difference between the proxy DMA unit 13-3 used in this embodiment and the proxy DMA unit 13-2 used in the second embodiment is in the connection of the input/output bus 47 into the proxy DMA controller 31. As those skilled in the art will appreciate, with this serial configuration all of the data transfers between the disk drive 11 and the system memory 3 pass through the proxy DMA unit 13, although they need not all be checksummed. In this embodiment, the CPU 1 can enable or disable the checksumming operation of the proxy DMA unit 13 prior to each transferring operation or by including it as an attribute in the address translation table if several transfers take place simultaneously between system memory 3 and two or more connected peripheral devices. One advantage of this serial architecture is that it reduces the number of accesses to the system address and control bus 5 and the system data bus 7.

Another advantage of the system architecture shown in FIG. 7 is that the operation of the proxy DMA unit 13-3 can be combined with the applicant's existing I/O bridge chips (such as the Sun Microelectronics STP2223BGA bridge chip) which provide address translation between addresses on the I/O bus 47 into appropriate physical addresses on the system address and control bus 5. It is therefore relatively simple to modify these existing I/O bridge chips to include the cache 31, the checksum calculation circuitry and the proxy DMA controller circuitry 31 necessary for performing the proxy DMA operation.

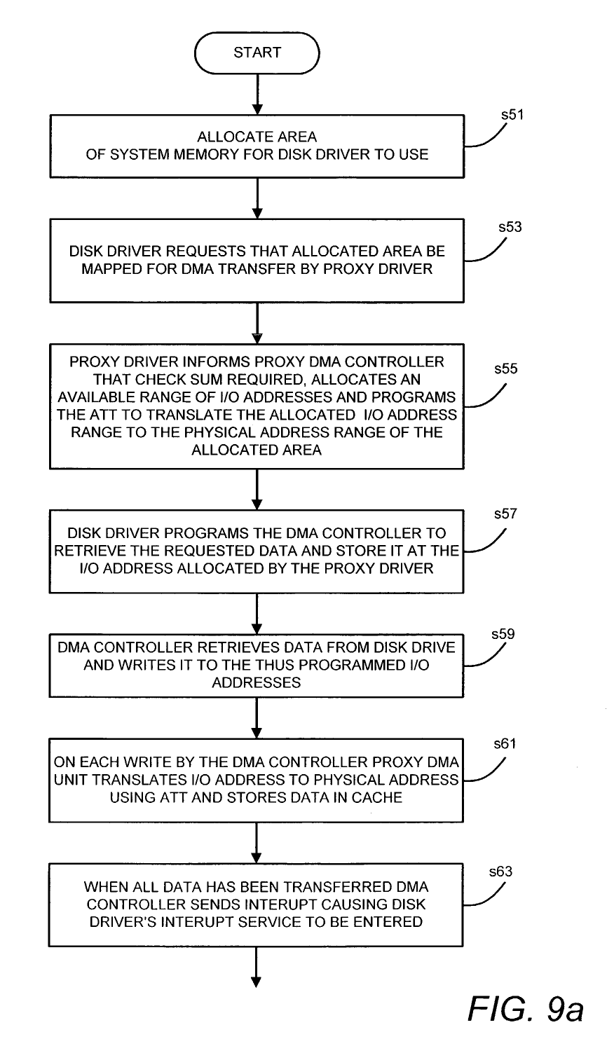

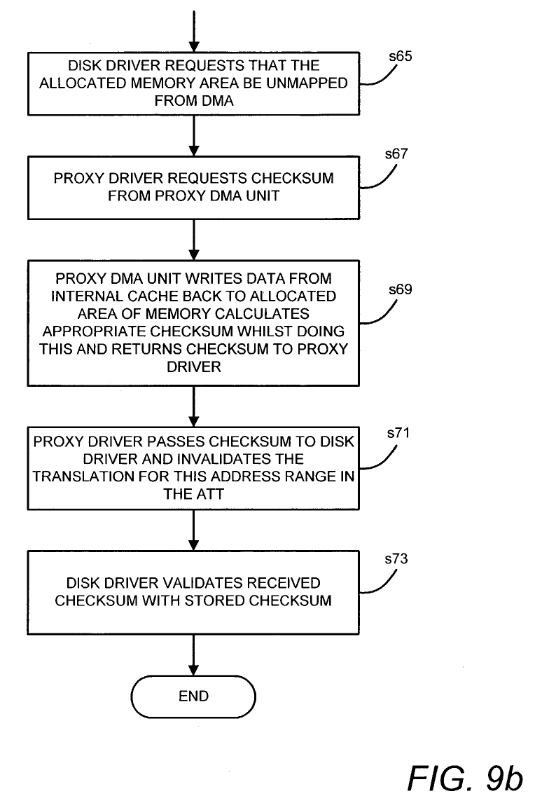

The typical actions involved in carrying out a DMA transfer of data from the disk drive 11 to the system memory 3 for the system shown in FIG. 7 will now be described with reference to the flow chart shown in FIGS. 9a and 9b. Initially, the disk driver 19 is allocated an area of the system memory 3 (s51). This allocation is performed by the operating system 15. The disk driver 19 then requests the proxy driver 51 to map the allocated area for DMA transfer (s53). In other words the disk driver 19 requests the proxy driver 51 to generate the appropriate address mappings for the address transfer table 47 located in the proxy DMA unit 13-3.

In response, the proxy driver 51: (i) informs the proxy DMA controller 31 that checksumming is required; (ii) allocates an available range of I/O addresses and passes these to the disk driver 19; and (iii) programs the address translation table 47 to translate the allocated I/O address range to the physical address range of the allocated area (s55).

The disk driver 19 then programs the DMA controller 9 to retrieve the requested data and to store it at the I/O addresses allocated by the proxy driver 51 (s57). In response, the DMA controller 9 retrieves the data from the disk drive 11 and writes the data to the thus programmed I/O addresses via the I/O bus 47 (s59). On each write by the DMA controller 9, the proxy DMA unit 13-3 translates the I/O address to the corresponding physical address using the address translation table 47 and stores the data in its internal cache (s61). Once all the data has been transferred the DMA controller 9 sends an interrupt back to the CPU 1 causing an interrupt service of the disk driver 19 to be entered (s63). Receipt of the interrupt causes the disk driver 19 to request the proxy driver 51 to unmap the allocated memory area for DMA transfer (s65). In response the proxy driver 51 requests the checksum from the proxy DMA unit 13-3 (s67). Upon receiving this request from the proxy driver 51, the proxy DMA unit 13-3 writes the data in the internal cache 33 back to the allocated area in the system memory 3 and whilst doing this calculates the appropriate checksum using the checksum calculation unit 35 and returns the check sum value to the proxy driver 51 (s69). The proxy driver 51 then passes the checksum to the disk driver 19 and invalidates the translation for the address range of the allocated area in the system memory 3 in the address translation table 47, so that further data will not be written into this allocated area accidentally without a further DMA operation being initiated (s71). The disk driver 19 then validates the received checksum with the checksum previously calculated when the data was read out from the system memory 3 (s73) and then the processing ends.

Modifications and Variations

A number of embodiments have been described above which illustrate the way in which a proxy DMA unit may be used to add hardware checksumming to DMA data transfers using conventional DMA controllers. Although the embodiments described above have been specific, it will be apparent to those skilled in the art that a number of modifications can be made to those embodiments. Some of these modifications will now be described for illustration.

In the above embodiments, the proxy DMA unit was arranged to write the data back to the system memory after all of the data had been transferred from the disk drive to its internal cache. This was done in order to facilitate the calculation of a checksum since a DMA controller may write to the same memory address more than once during a single DMA transfer. By keeping all the data in the internal cache the proxy DMA unit can simply overwrite data as appropriate and once the DMA transfer has been completed by the DMA controller the correct checksum value can be calculated. However, as those skilled in the art will appreciate, it is not essential to only transfer the data to the system memory after all of the data has been transferred from the disk drive to the internal cache. The proxy DMA unit may be arranged to write some of the data back to the system memory during the DMA transfer and as it does so to calculate partial checksums. Once all of the data has been transferred the proxy DMA unit can then calculate the final checksum from the partial checksums thus calculated. If the DMA controller rewrites to a part of memory that has already been written back to the main memory, then the proxy DMA unit can retrieve the appropriate partial block from memory, modify it and recalculate the corresponding partial checksum. As those skilled in the art will appreciate, such an embodiment reduces the cache size requirements of the proxy DMA unit.

Alternatively, the proxy DMA unit could simply write back partial blocks to the system memory whilst keeping a copy in its internal cache. If a partial block is then further modified by the DMA controller then the proxy DMA unit just rewrites that partial block of data to the system memory without having to retrieve the partial block first from system memory. Although this approach does not reduce the cache size required by the proxy DMA unit, it would decrease the time required at the end of the DMA transfer to copy the data back to the system memory (since some valid data will have already been copied during the transfer process).

In the above embodiments, the proxy DMA unit waited until it was asked to return the checksum value until it calculated the checksum and, if appropriate, copied the data into the system memory. Alternatively, the proxy DMA unit may be arranged to do this automatically when it detects the interrupt signal transmitted from the DMA controller to the CPU. At this time, the proxy DMA unit may automatically calculate the appropriate checksum value and, if appropriate, copy the data from its internal cache into the system memory.

In the above embodiments, the proxy DMA unit, the system memory and the DMA controller were arranged to respond to predetermined addresses on the system address bus. In practice this is done using an address decoder which monitors the signals applied to the address and control bus and outputs the appropriate chip select signals to these devices. The structure and operation of such address decoders is well-known to those skilled in the art and will not be described in more detail here.

In the first embodiment described above, where checksumming of the data to be transferred was required the CPU programmed the DMA controller to carry out the transfer via the proxy DMA unit. The first time that the proxy DMA unit knows about the data transfer is when the DMA controller writes data to or requests data from the proxy DMA unit. In an alternative embodiment, the CPU may inform the proxy DMA unit before it instructs the DMA controller. In this way, the proxy DMA unit can ready itself for the subsequent request from the DMA controller. Advance knowledge of the requested data allows the proxy DMA unit to retrieve the appropriate data from system memory for storage in its internal cache so that when the DMA controller requests the data, the data will be available immediately.

In the above embodiments, a computer system has been described in which a single DMA controller has been provided for controlling data transfers between system memory and a hard disk. As those skilled in the art will appreciate, the proxy DMA units described in the above embodiments may be used in systems having two or more storage devices connected through a respective DMA controller to the computer system.

In the above embodiments, the data transfer was between system memory and an external hard disk. As those skilled in the art will appreciate, the above proxy DMA unit may be used for data transfers between other types of storage devices (e.g. floppy or optical disk) or other peripheral devices such as another computer device.

In the above embodiments, the disk driver requested the checksumming and validated the checksums that were calculated. As those skilled in the art will appreciate, the checksumming may be controlled by a higher level of software such as the application software that the user is interacting with or by a lower level of software such as the operating system or, if there is one, the proxy driver.

In the above embodiments, the proxy DMA unit performed checksumming calculations on the data that is transferred between the external hard disk and the system memory. As those skilled in the art will appreciate, various checksumming algorithms may be used. Further, instead of checksumming, a more sophisticated error control system such as CRC (Cyclic Redundancy Checking) could be used. If a CRC algorithm is used and data is corrupted then the remedial procedures that can be initiated can try to correct the error using well-known error correcting techniques associated with the CRC algorithm. Alternatively, a simpler check may be provided by way of a simple parity bit. However, such an embodiment cannot detect if an even number of errors are introduced into the data that is transferred.

In the above embodiments, at the end of a data transfer operation transferring data from the external hard disk into the system memory, the proxy DMA unit copied the data from its internal cache into the system memory. In some computer systems, the CPU also includes an internal cache. In such an embodiment, the proxy DMA unit would also either write the data back to the CPU cache or signal to the CPU that the data stored in its cache may be invalid.

In the above embodiments, the proxy DMA unit was shown as a separate device attached to the system bus. The proxy DMA unit may be provided as a separate integrated circuit or may, indeed, form part of the CPU integrated circuit itself.

The software loaded into the system memory may be input to the computer as instructions on a data storage device, such as a CD ROM etc, and/or as instructions carried by a signal transmitted over a data network such as the Internet.

1. A computer system comprising:
a processing unit for controlling the operation of the computer system;
system memory for storing data used by the computer system;
a system bus for connecting the processing unit to the system memory;
a DMA controller coupled to said system bus for controlling data transfers between the system memory and an external peripheral device;
a further DMA unit which is coupled to said system bus;
wherein said processing unit is operable to program said DMA controller to write data to or request data from said further DMA unit;
wherein said further DMA unit comprises:
writing and reading circuitry for writing data to or reading data from said system memory in accordance with the data received or requested from said DMA controller;
output circuitry for outputting data read from said system memory to said DMA controller; and
calculating circuitry for calculating check data for the data written to or read from the system memory.

2. A system according to claim 1, wherein said further DMA unit is directly connected to said system bus.

3. A system according to claim 2, wherein said DMA controller is directly connected to said system bus.

4. A system according to claim 1, wherein said DMA controller is coupled to said system bus through said further DMA unit.

5. A system according to claim 4, wherein said DMA controller is connected to said further DMA unit via an input/output bus and wherein said further DMA unit forms part of a bridge circuit for providing a bridge between said input/output bus and said system bus.

6. A system according to claim 1, wherein said DMA controller is operable to write data to or request data from said further DMA unit together with data identifying an address of a storage location within said system memory to which the data is to be written or from which the data is to be read.

7. A computer system according to claim 6, wherein said further DMA unit further comprises an address translator for translating the address data received from said DMA controller to generate the actual address of said storage location within said system memory.

8. A system according to claim 7, wherein said address translator comprises an address translation table which defines a mapping between the received address data and the corresponding address in the system memory.

9. A system according to claim 1, wherein said further DMA unit further comprises a memory for storing data received from the system memory or the DMA controller and wherein said calculating circuitry is operable to calculate said check data from the data stored in said memory.

10. A system according to claim 9, wherein said memory comprises a cache memory.

11. A system according to claim 9, wherein said calculating circuitry is operable to calculate the check data at the end of a data transfer operation from the data stored in said memory.

12. A system according claim 9, wherein during a data transfer from said peripheral device to said system memory, said further DMA unit is operable to intermittently write blocks of data to said system memory, wherein said calculating circuitry is operable to calculate partial check data for the blocks of data written back to said system memory and wherein said calculating circuitry is operable to calculate final check data for a data transfer operation from the partial check data calculated during the data transfer operation.

13. A system according to claim 1, wherein said calculating circuitry is operable to calculate a check sum for the data written to or read from the system memory.

14. A system according to claim 1, wherein said calculating circuitry is operable to perform a cyclic redundancy check on the data written to or read from the system memory.

15. A system according to claim 1, wherein said further DMA unit is operable to transmit said check data to said processing unit at the end of the data transfer operation.

16. A system according to claim 15, wherein said processing unit is operable to store said check data if the data is read from the system memory to said peripheral device and is operable, when data is written to said system memory from said peripheral device, to compare the check data with stored check data obtained from said further DMA unit when the same data was previously read from the system memory to said peripheral device.

17. A system according to claim 16, wherein said processing unit is operable to output an error signal if said compared check data are different.

18. A system according to claim 1, wherein said peripheral device comprises a storage device.

19. A system according to claim 1, wherein said processing unit is operable to program said DMA controller in a first mode to write data to or request data from said further DMA unit and in a second mode to write data to or request data from said system memory directly.

20. A system according to claim 1, wherein said further DMA unit is configurable to enable or disable said calculating circuitry.

21. A system according to claim 20, wherein said processing unit is operable to configure the enablement or disablement of said calculating circuitry.

22. A system according to claim 1, wherein said processing unit is operable to program said DMA controller with address data that corresponds to said further DMA unit rather than physical memory locations within said system memory.

23. A proxy DMA unit for use in calculating check data for data transferred by a DMA controller between system memory of a computer system and an external peripheral device, the proxy DMA unit comprising:
circuitry for receiving data or requests for data from said DMA controller;
writing and reading circuitry for writing data to or reading data from said system memory in accordance with the data received or requested from said DMA controller;
output circuitry for outputting data read from said system memory to said DMA controller; and
calculating circuitry for calculating check data for the data written to or read from the system memory.

24. A proxy DMA unit according to claim 23, further comprising an address translator for translating address data received from said DMA controller to generate an actual address of a storage location within said system memory to which data is to be written or from which data is to be read.

25. A proxy DMA unit according to claim 24, wherein said address translator comprises an address translation table which defines a mapping between the received address data and the corresponding address in the system memory.

26. A proxy DMA unit according to claim 23, further comprising a memory for storing data received from the system memory or the DMA controller and wherein said calculating circuitry is operable to calculate said check data from the data stored in said memory.

27. A proxy DMA unit according to claim 26, wherein said memory comprises a cache memory.

28. A proxy DMA unit according to claim 26, wherein said calculating circuitry is operable to calculate the check data at the end of a data transfer operation from the data stored in said memory.

29. A proxy DMA unit according to claim 26, wherein during a data transfer from said peripheral device to said system memory, said proxy DMA unit is operable to intermittently write blocks of data to said system memory, wherein said calculating circuitry is operable to calculate partial check data for the blocks of data written back to said system memory and wherein said calculating circuitry is operable to calculate final check data for a data transfer operation from the partial check data calculated during the data transfer operation.

30. A proxy DMA unit according to claim 23, wherein said calculating circuitry is operable to calculate a check sum for the data written to or read from the system memory.

31. A proxy DMA unit according to claim 23, wherein said calculating circuitry is operable to perform a cyclic redundancy check on the data written to or read from the system memory.

32. A proxy DMA unit according to claim 23, operable to transmit said check data to a processing unit of said computer system at the end of the data transfer operation.

33. A proxy DMA unit according to claim 23, configurable to enable or disable said calculating circuitry.

34. A processing unit operable to control the transfer of data between the system memory of a computer system and an external peripheral device using a DMA controller and a further DMA unit, the processing unit being characterised in that it is operable to program said DMA controller to write data to or request data from said further DMA unit instead of from said system memory.

35. A processing unit according to claim 34, operable to receive check data from said further DMA unit at the end of a data transfer operation between said system memory and said external peripheral device, operable to store said check data if the data is read from the system memory to said peripheral device and operable, when data is written to said system memory from said peripheral device, to compare the check data with stored check data obtained from said further DMA unit when the same data was previously read from the system memory to said peripheral device.

36. A processing unit according to claim 35, operable to output an error signal if said compared check data are different.

37. A processing unit according to claim 34, operable to program said DMA controller in a first mode to write data to or request data from said further DMA unit and in a second mode to write data to or request data from said system memory directly.

38. A processing unit according to claim 34, wherein said further DMA unit is configurable to enable or disable calculation of check data for data transfers and wherein said processing unit is operable to configure said further DMA unit to enable or disable the calculation of said check data.

39. A central processing unit for a computer apparatus, comprising an integrated circuit which includes the proxy DMA unit according to claim 23.

40. A bridge circuit for providing an interface between an input/output bus and a system bus of a computer apparatus, the bridge circuit comprising a proxy DMA unit according to claim 23.

41. A computer instruction carrier medium carrying instructions for causing a programmable processing apparatus to control a data transfer operation between system memory of a computer system and an external peripheral device using a DMA controller and a further DMA unit, the instructions comprising instructions for programming said DMA controller to write data to or request data from said further DMA unit instead of from said system memory.

42. A computer instruction carrier medium according to claim 41, wherein the instructions further comprise instructions for receiving check data from said further DMA unit at the end of a data transfer operation between said system memory and said external peripheral device, instructions for storing said check data if the data is read from the system memory to said peripheral device and instructions, when data is written to said system memory from said peripheral device, to compare the check data with stored check data obtained from said further DMA unit when the same data was previously read from the system memory to said peripheral device.

43. A computer instruction carrier medium according to claim 42, further comprising instructions for outputting an error signal if said compared check data are different.

44. A computer instruction carrier medium according to claim 41, further comprising instructions for programming said DMA controller in a first mode to write data to or request data from said further DMA unit and in a second mode to write data to or request data from said system memory directly.

45. A computer instruction carrier medium according to claim 41, further comprising instructions for configuring said further DMA unit to enable or to disable check data calculation circuitry within the proxy DMA unit.

46. A computer instruction carrier medium according to claim 41, wherein the instructions form part of an operating system for the computer apparatus.

47. A computer instruction carrier medium according to claim 41, wherein the instructions form part of a driver associated with the external peripheral device.

48. A computer instruction carrier medium according to claim 41, wherein the carrier medium is one of a storage device and a signal.

49. A method of operating a computer system having a processing unit, a system memory, a DMA controller and a further DMA unit, the method comprising the steps of:
programming said DMA controller to write data to or request data from said further DMA unit;
writing data or reading data from said system memory and outputting read data to said DMA controller in accordance with the data received or requested from said DMA controller; and
calculating check data for the data written to or read from the system memory.
